(19) United States
(12) Patent Application Publication
(10) Pub. No.: US 2010/0199270 A1
(43) Pub. Date: Aug. 5, 2010

(54) SYSTEM, METHOD, AND COMPUTER-PROGRAM PRODUCT FOR SCALABLE REGION-BASED REGISTER ALLOCATION IN COMPILERS

(76) Inventor: Ivan Baev, Cupertino, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/362,880

(22) Filed: Jan. 30, 2009

(51) Int. Cl. G06F 9/45

(52) U.S. Cl. 717/157; 717/151

(57) ABSTRACT

A region-based register allocation system, method, and computer-program product not only provides a scalable framework across multiple applications, but also improves application runtime. They include a register pressure based model, to determine when using multiple regions may be profitable, the use of different regions for each register class, and a new region formation algorithm.

### COPYRIGHT NOTICE

Portions of the disclosure of this patent document contain material which is subject to copyright protection. The copyright owner has no objection to the facsimile reproduction by anyone of the patent document or the patent disclosure, as it appears in the patent and trademark office patent files or records, but otherwise reserves all copyright rights whatsoever.

### BACKGROUND OF THE INVENTION

1. Field of the Invention

The present invention relates generally to processor register allocation, and more specifically to region-based register allocation.

2. Statement of the Prior Art

Register allocation is an important component of every compiler. The goal of register allocation is to optimally assign program variables and compiler-generated temporaries to available hardware registers. For most processors, an optimal register allocation minimizes both register usage and generated spill code. For processors with a register stack (e.g., Itanium® processors manufactured by Intel Corporation, Santa Clara, Calif. USA), an optimal register allocation not only minimizes register stack engine spills, but it also reduces memory spills.

Standard graph coloring register allocation techniques work well on small or medium size programs, but fail to deliver good performance on large applications compiled with aggressive inlining and high-level optimizations. Moreover, conventional allocation methods may take an enormous amount of compile-time and/or memory.

Conventional region-based register allocators typically start by first partitioning the procedure and then allocating each region separately. Such register allocators either trade the run-time quality for compile-time and memory use guarantees, or improve run-time at the expense of a substantial increase in compile-time.

Since register allocation is usually preceded by instruction scheduling, region-based allocators conveniently reuse the regions formed earlier by the scheduler. While this approach reduces the compile-time, it does not deliver better run-time performance. For example, some conventional compilers select a region and perform global and ILP (i.e., instruction-level parallelism) optimizations, scheduling, and register allocation on these regions. While this region-based allocator is on average faster and requires less memory than a global allocator, the execution times of code generated by the two allocators are comparable. Other conventional region-based allocators improve on this region formation algorithm by a demand driven inlining, which further reduces the memory consumption at the expense of an increased execution time.

### BRIEF DESCRIPTION OF THE DRAWINGS

Embodiments will now be described in connection with the associated drawings, in which:

FIG. 1 depicts a flowchart illustrating a method for allocating register space according to a first embodiment of the present invention;

FIG. 2A depicts a flowchart illustrating the partitioning step of FIG. 1 according to one embodiment of the present invention;

FIG. 2B depicts a flowchart illustrating the partitioning step of FIG. 1 according to another embodiment of the present invention;

FIG. 2C depicts a flowchart illustrating the partitioning step of FIG. 1 according to yet another embodiment of the present invention;

FIG. 2D depicts a flowchart illustrating a method of allocating register space according to a second embodiment of the present invention;

FIG. 2E depicts a flowchart illustrating the calculating step according to embodiments of the present invention as shown in FIGS. 1 and 2D;

FIG. 3 depicts a core graph coloring algorithm according to still another embodiment of the present invention; and

FIG. 4 depicts a block diagram of a computing system according to embodiments of the present invention.

### DETAILED DESCRIPTION OF THE EMBODIMENTS

Exemplary embodiments are discussed in detail below. While specific exemplary embodiments are discussed, it should be understood that this is done for the purposes of illustration only. In describing and illustrating such exemplary embodiments, specific terminology may be employed for the sake of clarity. However, these embodiments are not intended to be limited to the specific terminology so selected. One of ordinary skill in the relevant art will readily appreciate that other components and configurations may be used without departing from the spirit and scope of these embodiments. It should be understood that each specific component and configuration includes all technical equivalents that operate in a similar manner to accomplish a similar purpose. The examples and embodiments described herein are, therefore, to be understood as non-limiting examples.

Modern processors, such as Intel's Itanium® processors, provide a large number of registers to accommodate the needs of applications compiled with aggressive scalar and ILP exposing transformations. Such registers are generally divided as follows: 128 64-bit general registers each with an extra bit used to determine whether the contents are valid, 128 82-bit floating-point registers, 64 1-bit predicate registers representing Boolean values for conditional expressions, 8 64-bit branch registers capable of storing full address pointers used in function call and return linkage, and up to 128 64-bit application registers accommodating address pointers and signed/unsigned integers that provide support for specific architectural features. Other register sets provide user and system level support for tasks such as storing state information in hardware, processor information and performance monitoring data.

The integer register file contains 128 general purpose registers (Gpr), in which the lower 32 registers are typically static and the upper 96 registers are typically stacked. A procedure may allocate a variable sized register stack frame composed of up to 96 registers. The stack frame is divided into incoming argument registers, local registers, and outgoing argument registers. A subset of the stack frame can be specified to rotate in the context of a software pipelined loop. The registers in the register stack are managed by the register stack engine. The incoming argument and local registers are seen by the register allocator as being preserved by procedure calls.

The floating-point register file also contains 128 floating point registers (Fpr). Unlike the integer register file, the upper 96 floating-point registers are not stacked, and all of these 96 registers rotate in the context of a software pipelined loop. The Itanium® calling convention specifies that the upper 96 floating-point registers are “scratch” (i.e., not preserved across procedure calls).

The partitioning of the floating-point register file presents an interesting challenge to code generation and register allocation. The fact that the upper 96 floating-point registers are scratch and rotating has severe implications to a floating-point live range that spans either a procedure call or a software pipelined loop; such a live range cannot be assigned to any of the upper 96 floating-point registers. This can be compared to the situation with an integer live range that spans either a call or a software pipelined loop: the incoming argument and local registers in the register stack frame are preserved across a call, and not all of the register stack frame necessarily rotates.

In addition to Gpr and Fpr registers, a set of 64 1-bit predicate registers are used to hold the results of compare instructions. The first 16 predicate registers are static. The rest are rotating and may be programmatically renamed to accelerate software pipelined loops. Finally, a set of 8 64-bit branch registers are used to hold branching information: the branch target addresses for indirect branches.

The task of reducing of spill code is still important, even for compilers targeting processors such as Itanium® with a large number of registers. Given the ever increasing gap between memory and processor performance, more variables are placed in registers and more aggressive optimizations are enabled. This trend naturally leads to very large procedures which, given the quadratic nature of graph coloring allocation and other optimization phases, provide extra motivation to region-base compilation and its proper scaling.

One may consider the measure of register pressure at a given program point, that is the number of overlapping live ranges at that program point. Gpr register pressure may denote the highest number of overlapping integer live ranges over all program points in a procedure, and Fpr register pressure may denote the highest number of overlapping floating-point live ranges over all program points in a procedure. Clearly, if register pressure exceeds the number of available physical registers, selected live ranges must be spilled to and reloaded from memory, which can degrade overall performance.

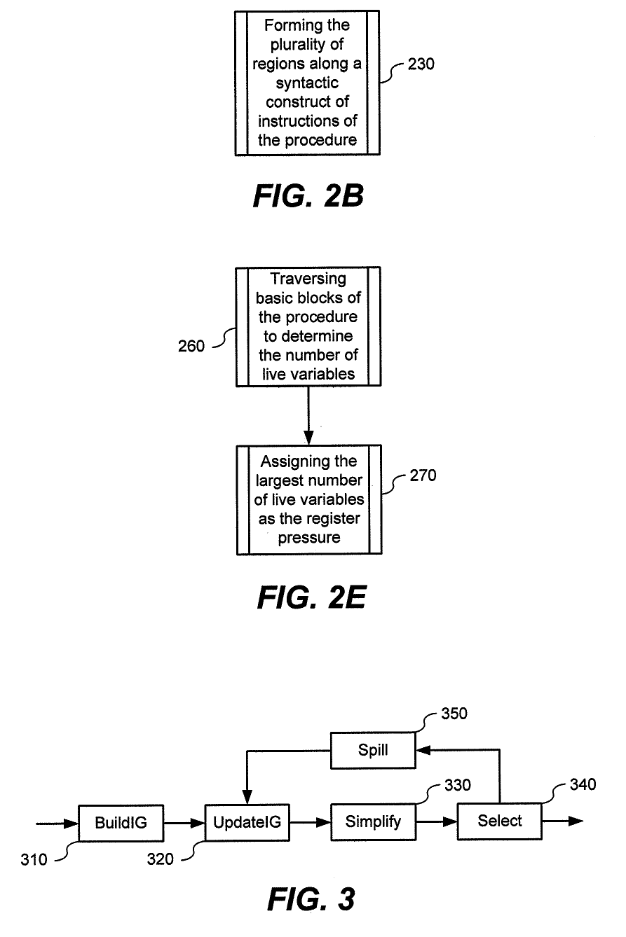

Referring first to Table I, Gpr and Fpr register pressure may be calculated at the beginning of the register allocation component for the two most important procedures from each of twelve SPEC2006 INT and FP benchmarks. FIG. 2D illustrates a use of this process to determine whether the register pressure exceeds an established threshold. Given the levels of register pressure, register allocation for about a half of procedures in the table will require the insertion of spill code.

TABLE I

| | | Gpr | Fpr |
|---|---|---|---|
| | | Register | Register |
| Benchmark | Procedure | Pressure | Pressure |
| 410.perlbench | S_Regmatch | 43 | 1 |
| | S_find_byclass | 32 | 0 |
| 429.mcf | primal_net_simplex | 75 | 3 |
| | price_out_impl | 52 | 2 |
| 464.h264ref | SetupFastFullPelSearch | 156 | 1 |
| | RDCost_for_4×4IntraBlocks | 73 | 1 |
| 410.bwaves | bi_cgstab_block | 133 | 52 |
| | shell | 338 | 163 |
| 416.gamess | genral | 220 | 118 |
| | dirfck | 128 | 40 |
| 433.milc | eo_fermion_force | 121 | 99 |
| | imp_gauge_force | 97 | 4 |
| 434.zeusmp | hsmos | 356 | 99 |
| | lorentz_d | 379 | 92 |
| 444.namd | calc_pair-energy_fullelect | 91 | 99 |
| | calc_pair-fullelect | 91 | 92 |
| 454.calculix | Chv_updateS | 75 | 72 |
| | e_3cd | 206 | 157 |
| 459.GemsFDTD | leapfrog | 254 | 46 |
| | nft_store | 310 | 109 |
| 465.tonto | form_esfs | 111 | 43 |
| | make_esss | 249 | 51 |
| 483.sphinx3 | form_esfs | 67 | 66 |
| | make_esss | 185 | 59 |

The first three benchmarks (i.e., 400.perlbench, 429.mcf, and 464.h264ref) exemplify integer intensive applications such as commercial databases and transactional servers. Most procedures in such applications when compiled at the highest optimization level exhibit substantial Gpr register pressure and close to zero Fpr register pressure.

The remaining benchmarks in Table I are floating point intensive applications representing scientific simulation, forecasting, and CAD/CAM computations. The procedures in these applications when compiled at the highest optimization level exhibit substantial Fpr and Gpr register pressures. It may be noted that, given the asymmetry between Fpr and Gpr classes as explained herein below, for most FP-related procedures the effective Fpr register pressure is actually higher than Gpr register pressure.

For integer procedures like SetupFastFullPelSearch( ) from 464.h264ref, the register pressure values suggest that while a global (i.e., single region) register allocation for Fpr class will be sufficient, a scalable allocation for Gpr class will require multiple regions. In presence of software pipelined loops that make all 96 FP rotating registers in such loops unavailable, the situation is reverse. For example, the allocation of calc_pair_energy_fullelect( ) from 444.namd will require a single region for Gpr class, and multiple regions for Fpr class. In the case of shell( ) from 410.bwaves with very high Gpr and Fpr register pressures, an optimal allocation might require multiple regions for both classes. However, if the largest number of overlapping integer live ranges and the largest number of overlapping floating-point live ranges occur at different program points, the best region structure for Gpr class may be different from the best region structure for Fpr class.

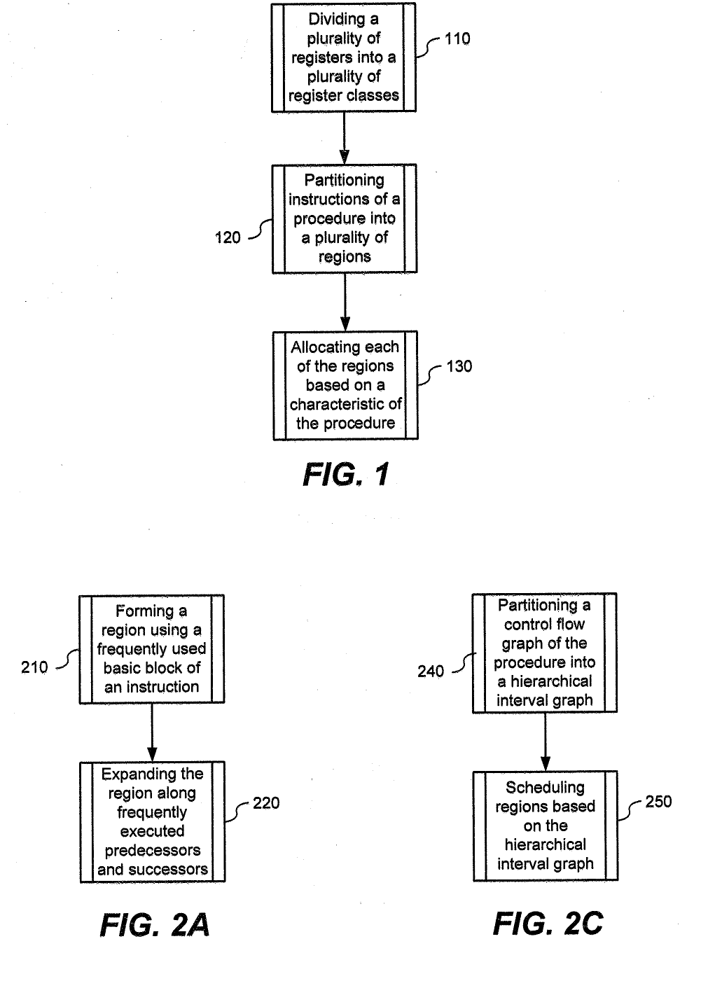

As noted herein above, prior region-based register allocation methods either trade run-time quality for compile-time and memory use guarantees, or improve run-time at the expense of a substantial increase in compile-time. In accordance with embodiments of the present invention shown and described herein below with reference to FIGS. 1, 2A-2E, 3, and 4, this scalability problem may be solved by extending a basic region-based register allocator with three innovative features: (1) a new model for estimating the need of partitioning; (2) allowing the allocation of each register class to use a different region type determined by the characteristics of the procedure; and (3) a new algorithm for region formation.

### Estimating the Need of Partitioning

Most region-based register allocators use ad hoc methods to decide whether to partition the application for better performance, typically counting instructions or basic blocks in the function. As is known to those of ordinary skill in the art, a basic block is code that has one entry point (i.e., no code within it is the destination of a jump instruction), one exit point and no jump instructions contained within it. The start of a basic block may be jumped to from more than one location. The end of a basic block may be a jump instruction or the statement before the destination of a jump instruction. Basic blocks are usually the basic unit to which compiler optimizations are applied. Basic blocks form the vertices or nodes in a control flow graph. The code may be source code, assembly code or some other sequence of instructions. More formally, a sequence of instructions forms a basic block if the instruction in each position dominates, or always executes before, all those in later positions, and no other instruction executes between two instructions in the sequence.

While these simple heuristics could be valuable for forming scheduling regions, the number of instructions does not determine the complexity and performance of the register allocation process. The register allocation goal is to minimize the amount of spill code and that amount is proportional to the register pressure—the number of simultaneously live registers—along paths in the procedure control-flow graph. Therefore, any partitioning heuristic should include a measure of register pressure. It should be noted at this juncture that a function may contain a large number of instructions, but if most of its variables have short ranges, register allocation is fast.

As shown in FIG. 2E, one solution starts with the sets of live variables at the beginning of each basic block. The sets are readily available from the standard data-flow analysis that precedes the register allocator. Each basic block may be traversed at 260 in a forward way to find the number of live variables at each instruction, and remember the largest number over all instructions in the basic block. This value is assigned at 270, and represents the register pressure for the basic block. The greatest register pressure over all basic blocks determines the register pressure for the function. Clearly, if the register pressure exceeds the number of hardware registers then spilling is necessary. On the other hand, if the register pressure of the function is not greater than the number of registers then one may proceed by allocating the whole function as a single region. In this manner, one may improve compilation time by avoiding the unnecessary division of the procedure and avoiding the allocation of multiple small—in terms of register pressure—regions. This register pressure model may be applied for each register class in the processor. For predicate and branch register classes, one may typically determine that their register pressure is low and proceed with a singe region consisting of the entire function. For integer oriented applications, the register pressure model recommends multiple regions for Gpr class and a single region for Fpr class. For floating-point intensive programs the register pressure model guides one to use multiple regions for both Gpr and Fpr classes.

An important decision in each region-based allocator design concerns the order in which regions are allocated. Intuitively, one may like to allocate frequently executed regions and regions with highest register pressure first.

If a variable is live in multiple regions, the register allocator tries to assign it to the same hardware register in all these regions. The regions may be ordered by the number of their live-in and live-out live ranges, giving a higher priority to a region with a larger number of such ranges.

### Use of a Different Region Type Determined by the Characteristics of the Procedure

Most general-purpose processors have at least two separate register files for general-purpose and floating-point registers. In addition, processors with full predication support exhibit a predicate register file, and processors with split branch support have a branch register file. Intel Itanium® processors have these four register classes.

A simple region-based register allocator uses the same type of regions for all register classes of the processor. The register allocator driver typically begins by selecting regions, and then using the same regions allocates the registers for each register class in turn. However, most applications are either integer or floating-point intensive, so there rarely exists a region structure good for both Gpr and Fpr classes. If the processor has branch or predicate registers, their reference patterns typically do not require multiple regions. Furthermore, on many processors Gpr and Fpr classes are not symmetric in resources and functionality.

Referring for the moment to FIG. 1, there is shown a compiler arranged to allocate register space among a plurality of registers in a processor (not shown), wherein the compiler includes a divider (which may assume the form of code sequences) 105 for dividing the plurality of registers into a plurality of register classes, and for each such register class from said plurality of register classes, a partitioner (which may assume the form of code sequences) 120 for partitioning instructions of a procedure into a plurality of regions, and an allocator (which may assume the form of code sequences) 130 for allocating each of said plurality of regions to the plurality of registers in said register class based on a characteristic of said procedure.

According to embodiments of the present invention, the region-based register allocator may be extended to select different regions for each register class as dictated by the characteristics of the compiled application. For predicate and branch register classes, one may usually determine that their register pressure is low and proceed with a single region consisting of the entire function. For most integer-oriented applications, the allocation of Gpr class registers requires multiple regions. For most floating-point applications, there may be multiple regions for Fpr class registers. For mixed-mode applications, the register pressure model recommends multiple regions for both Gpr and Fpr classes, but the structure of the Gpr and Fpr regions is usually different.

Once one has determined that a register class requires multiple regions, the next step is to find the best region structure for that register class in the procedure being allocated. Compiler researchers have studied different regions for better performance, compile-time, and memory use. The two most common are syntax-based regions and frequency-based regions. In the former approach, regions are formed along the syntactic constructs in the source language, typically loops and switch statements, as shown in FIG. 2B. Such regions are useful when profile information is not readily available. In the latter approach, one may start with the most frequently executed basic block in the procedure as a seed, as shown in FIG. 2A, and grow the regions along the frequently executed predecessors and successors of the seed. Such regions are appropriate when very good profile information is available.

### Algorithm for Region Formation

Embodiments of the present invention are directed to a complier and methods for region formation in absence of profile information. Before describing the nodeRegion algorithm for region formation, the following will introduce the intervals and scheduling regions coming into the register allocator from the preceding scheduling component.

The instruction scheduler is a global, region-based list scheduler that makes use of predicated operations, control speculation, and data speculation to maximize the opportunities of exposed ILP across multiple basic blocks. In order to form scheduling regions, the control flow graph (CFG) of a function may be partitioned into a hierarchical interval (e.g., based on Tarjan's definition) graph as shown in FIG. 2C. The graph is made hierarchical by the virtue of the fact that the local CFG for each interval contains only the basic blocks that make up that interval; nested intervals are represented by a summary node. An interval, local CFG is acyclic with the exception of the local CFG of an improper interval. Scheduling regions are then constructed as a single-entry, multiple-exit subgraph of an interval, local CFG. A region may not span an interval boundary, but the region may contain the summary node that represents a nested loop or a nested region.

One exemplary embodiment of the nodeRegions formation algorithm of the present invention is shown below in C++ high-level code format.

(1) unsigned int maxRegionSize = 600;
(2) unsigned int minRegionSize = maxRegionSize/2;
(3) Region* processNode(Node& node, RegionList& list)
(4) {
(5) Region* currentRegion = new Region( );
(6) Region* previousRegion = NULL;
(7) //
(8) // Iterate over node's immediate children:
(9) // basic blocks, intervals, and schedRegions
(10) //
(11) for (ImmedChildIterator children(node); children != 0; ++children) {
(12) Node& child = *children;
(13) if (child.nodeType( ) == BasicBlock)
(14) currentRegion->add(child);
(15) else { // Interval or SchedRegion
(16) // recursively process the child node
(17) Region* childRegion = processNode(child, list);
(18) if (childRegion != NULL) {
(19) // merge childRegion to the current region
(20) currentRegion->merge(childRegion);
(21) }
(22) // Check if the current region has enough instructions to form a region
(23) if (currentRegion->instNumber( ) > maxRegionSize) {
(24) list.add(currentRegion); // finish the region
(25) previousRegion = currentRegion;
(26) currentRegion = new Region( ); // start a new region
(27) }
(28) }
(29) }
(30) //
(31) // Finish processing the current region
(32) //
(33) if (currentRegion->isNull( )) { // the current region is empty
(34) delete currentRegion;
(35) return NULL;
(36) }
(37) // Either finish the current region or
(38) // merge it to the last region formed if exists or
(39) // pass it to the parent node
(40) if (currentRegion->instNumber( ) > minRegionSize) {
(41) list.add(currentRegion);
(42) return NULL;
(43) }
(44) else if (previousRegion) {
(45) previousRegion->merge(currentRegion);
(46) return NULL;
(47) }
(48) else
(49) return currentRegion;
(50) }

The foregoing algorithm builds on the existing interval structure and regions constructed during the preceding scheduling phase. It iterates over the immediate children of the each non-basic block node (by the loop on lines 11-29) and recursively traverses inner interval and scheduler regions nodes (line 17). The region formation process starts with the top-level interval node that contains the entire procedure. A new register allocation region is formed and added to the list of the regions when maxRegionSize (line 24) is reached, or minRegionSize if one processes the last children of the node (line 41). By keeping the last formed region, one may ensure that no region is larger than about 1.5 times maxRegionSize.

The threshold values imply that the register allocation regions are about six times larger than the scheduling regions.

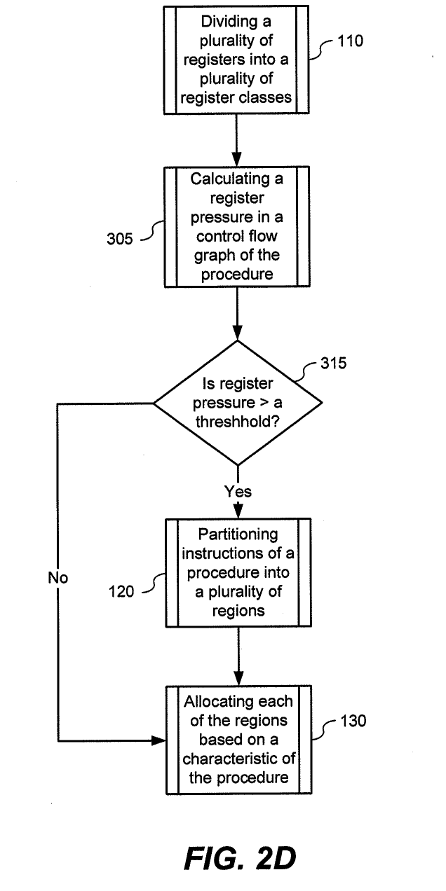

Before describing how contributions according to embodiments of the present invention fit into the structure of the register allocator, one may recall the core graph coloring algorithm. The register allocator in the compiler is graph coloring based, and employs the standard loop of build/update the interference graph, color, and spill until a successful allocation is achieved. The block diagram of the core algorithm is shown in FIG. 3. This loop is executed for each region selected in the procedure for each register class.

Each allocator begins with a liveness analysis, followed by building the interference graph whose nodes represent the live ranges in the program and edges represent the overlap between the live ranges. The simplify-and-select component determines the order in which the live ranges will be colored. If coloring is successful one may exit the loop. Otherwise live ranges may be spilled, the interference graph may be updated, and then the simplify-and select components may be continued. The register classes may be colored in the following order: predicate, branch, floating-point and integer. The order amongst predicate, branch and floating-point register classes may not be important. However, spill code generated by those classes introduces new integer live ranges, hence they may precede coloring of the integer class.

One top-level structure of the register allocator according to embodiments of the present invention is shown in the pseudo code below. After a global, predicate-aware dataflow analysis (line 3) that determines the live variable information, one may enter the loop for a register class allocation (lines 4-11). Based on the register pressure and instruction count one may decide if a single (i.e., global) region or multiple regions will be used for the register class (line 5), followed by the register formation step. The resulted regions are then allocated in a priority order (line 8), and the compensation code generation (line 9) ensures the consistency among allocation decisions for each variable allocated in the current and previously allocated regions.

(1) registerAllocation( )
(2) {
(3) livenessDataflowAnalysis( );
(4) for_each_register_class regClass (Branch, Predicate, Fpr, Gpr) {
(5) singleOrMultipleRegions(regClass);
(6) regionList = regionFormation(regClass);
(7) for_each_region rgn (regionList) {
(8) allocateRegion(rgn); // graph coloring allocation core from Fig. 3.
(9) compensationCode(rgn);
(10) }
(11) }
(12) }

The following addresses an evaluation of the nodeRegion formation algorithm along with the register pressure region heuristics. They all have been implemented in the HP-UX production compilers for the Intel Itanium® architecture. Compile-time and run-time experiments were performed on an Itanium® 2 processor under the HP-UX operating system. The baseline in those experiments was obtained by compiling the SPEC2006 FP suite of benchmarks with very aggressive switches (e.g., +O4+Ofaster) which include all interprocedural, loop, and lowlevel optimizations.

The compiler employs a graph coloring-based global register allocator, which may include prematerialization prior to dataflow liveness analysis and Briggs-style rematerialization at spill time, but may not perform any explicit live range splitting. The implicit splitting is achieved through region formation: region boundaries provide coarse grained split locations. The register allocator follows the main scheduler, which produces a tight schedule with VLIW words/bundles carefully formed for best performance. By compile-time considerations, the register allocator is followed by a local scheduler, which is only invoked on the basic blocks where spilling occurred.

While a fine grained live range splitting with a region may be feasible, the back-end structure discourages an aggressive live range spitting because that would require an additional invocation of the global scheduler after the register allocator.

Floating-point intensive applications are used because most previous studies on region-based allocation only evaluated integer intensive applications. In addition, since most SPEC2006 FP benchmarks exhibit high register pressure in both Gpr and Fpr classes as shown in Table I, register allocation of such applications may be very challenging. No profiling or training is assumed. That is, the compile- and run-time statistics are collected through a single compilation pass and a single execution of the application binary, respectively.

The following compares compile-time and run-time performance of the nodeRegion allocator to a global allocator which operates on a single region comprising the entire function. To explore the space of syntax-based regions, data for allocators that use schedRegions and interval (loop) regions may be collected as well. All four allocators may be implemented in the framework described herein above.

The compile-times of the major components of the four allocators may first be measured. Table II depicts each allocator's total time in the last column, as well as the times for: (a) region formation and compensation code generation; (b) interference graph build and update; (c) simplify and select; and (d) spill code generation.

TABLE II

| | Region | RegionForm | IG | Simplify | | Allocator |
|---|---|---|---|---|---|---|
| Benchmark | Type | CompCode | Built Update | Select | Spill | Total |
| 410.bwaves | global | — | 0.7 | 0.3 | 0.1 | 1.1 |
| | sched | 0.1 | 1.4 | 0.6 | 0.1 | 2.1 |
| | interval | 0.1 | 1.0 | 0.5 | 0.3 | 1.8 |
| | node | 0.1 | 0.6 | 0.2 | <0.05 | 0.9 |
| 416.gamess | global | — | 555.2 | 459.8 | 206.8 | 1231.0 |
| | sched | 732.4 | 1953.2 | 1001.2 | 331.4 | 4018.2 |
| | interval | 89.7 | 1863.1 | 337.7 | 103.1 | 2393.5 |
| | node | 249.5 | 458.6 | 101.4 | 21.2 | 830.7 |
| 433.milc | global | — | 1.8 | 0.3 | <0.05 | 2.2 |
| | sched | <0.05 | 2.1 | 0.4 | <0.05 | 2.5 |
| | interval | <0.05 | 2.0 | 0.5 | <0.05 | 2.5 |
| | node | <0.05 | 1.8 | 0.4 | <0.05 | 2.3 |
| 434.zeusmp | global | — | 16.3 | 14.1 | 2.8 | 33.3 |
| | sched | 4.4 | 35.1 | 18.4 | 3.0 | 60.7 |
| | interval | 2.3 | 29.1 | 12.0 | 1.9 | 45.2 |
| | node | 1.5 | 15.6 | 6.4 | 0.9 | 24.4 |
| 435.gromacs | global | — | 9.3 | 2.2 | 0.2 | 11.8 |
| | sched | 0.6 | 12.7 | 3.9 | 0.1 | 17.3 |
| | interval | 0.4 | 10.5 | 2.3 | <0.05 | 13.2 |
| | node | 0.4 | 9.5 | 1.6 | 0.1 | 11.5 |
| 436.cactusADM | global | — | 6.8 | 1.4 | 0.2 | 8.6 |
| | sched | 0.7 | 10.8 | 3.6 | 0.2 | 15.4 |
| | interval | 0.6 | 8.8 | 2.2 | 0.1 | 11.8 |
| | node | 0.4 | 6.9 | 1.2 | 0.1 | 8.5 |
| 437.leslie3d | global | — | 1.9 | 1.3 | 0.4 | 3.6 |
| | sched | 0.3 | 3.5 | 2.2 | 0.2 | 6.2 |
| | interval | 0.2 | 2.7 | 1.5 | 0.2 | 4.7 |
| | node | 0.1 | 1.7 | 0.9 | 0.2 | 2.9 |
| 444.namd | global | — | 3.4 | 0.7 | <0.05 | 4.1 |
| | sched | 0.4 | 4.9 | 1.6 | <0.05 | 6.9 |
| | interval | 0.3 | 4.4 | 1.0 | <0.05 | 5.7 |
| | node | 0.2 | 3.4 | 0.7 | <0.05 | 4.2 |
| 447.dealII | global | — | 51.9 | 10.9 | 0.6 | 64.0 |
| | sched | 4.1 | 70.4 | 19.3 | 1.1 | 94.8 |
| | interval | 3.0 | 65.6 | 12.8 | 0.4 | 81.8 |
| | node | 2.0 | 50.6 | 8.9 | 0.1 | 61.7 |
| 450.soplex | global | — | 7.6 | 1.0 | 0.0 | 8.7 |
| | sched | 0.3 | 7.6 | 1.2 | 0.0 | 9.0 |
| | interval | 0.2 | 7.4 | 1.0 | 0.0 | 8.7 |
| | node | 0.2 | 7.6 | 1.0 | 0.0 | 8.8 |
| 453.povray | global | — | 9.0 | 1.8 | 0.0 | 11.0 |
| | sched | 0.4 | 9.6 | 2.0 | 0.1 | 12.1 |
| | interval | 0.4 | 9.3 | 1.8 | <0.05 | 11.5 |
| | node | 0.3 | 9.3 | 1.6 | <0.05 | 11.2 |
| 454.calculix | global | — | 42.5 | 53.4 | 8.8 | 105.3 |
| | sched | 35.9 | 86.7 | 40.8 | 5.5 | 168.8 |
| | interval | 5.1 | 85.8 | 39.9 | 4.9 | 135.8 |
| | node | 10.6 | 33.4 | 7.5 | 0.8 | 52.2 |
| 457.GemsFDTD | global | — | 19.1 | 10.9 | 5.4 | 35.7 |
| | sched | 6.0 | 70.6 | 37.5 | 11.0 | 125.1 |
| | interval | 4.0 | 66.9 | 27.1 | 8.2 | 106.2 |
| | node | 2.2 | 16.9 | 4.7 | 0.9 | 24.7 |
| 465.tonto | global | — | 81.8 | 37.5 | 8.3 | 129.1 |
| | sched | 30.0 | 187.3 | 85.2 | 9.5 | 312.0 |
| | interval | 11.1 | 156.4 | 53.3 | 7.3 | 228.2 |
| | node | 10.6 | 80.1 | 21.4 | 1.9 | 113.9 |
| 481.wrf | global | — | 86.5 | 67.7 | 15.4 | 170.1 |
| | sched | 19.1 | 204.8 | 102.5 | 17.1 | 343.5 |
| | interval | 10.8 | 169.2 | 71.5 | 14.0 | 1.8 |
| | node | 6.8 | 88.6 | 31.2 | 6.1 | 0.9 |
| 482.sphinx3 | global | — | 1.8 | 0.4 | <0.05 | 2.2 |
| | sched | 0.2 | 2.6 | 0.9 | <0.05 | 3.7 |
| | interval | 0.1 | 2.1 | 0.4 | <0.05 | 2.6 |
| | node | 0.1 | 1.9 | 0.4 | <0.05 | 2.3 |

For each benchmark, one may sum the corresponding component and total times of all procedures comprising the benchmark, including the procedures where the register pressure model and singleOrMultipleRegions( ) force a global allocation. In this implementation, the predicate-aware dataflow analysis is on global basis and its time is identical for all four allocators, so its time has not been reported. Times for 470.lbm have also not been reported, because its total allocation time is less than 0.1 seconds.

The nodeRegions allocator disclosed herein significantly outperforms the global allocator, by up to 50% for 454.calculix. The total register allocation time over all benchmarks for globalRegions is 1822 seconds versus 1293 seconds for nodeRegions, which is a 29% decrease. It should be noted that the improvements for large procedures are bigger, for example, as much as 3× for dgetrf( ) in 454.calculix and 2× for nft_init( ) in 459.GemsFDT. Even though time is spent to form regions and generate compensation code between regions, substantial savings come from allocating smaller regions. The times for each core allocator component (i.e., interference graph build and update, color, and spill) decrease compared to the corresponding times for the global allocator. While the interference graph build times are close, the largest decrease occurs in the coloring component which implies that the number of unconstrained nodes substantially increases for the nodeRegions allocator.

It may be noted that both schedRegions and intervalRegions take more time then globalRegion, due to the large number of small regions. The fact that the times for region formation and compensation code generation for the three region-based allocators increase almost linearly from nodeRegions through intervalRegions to schedRegions on most benchmarks may imply the linear increase of the number of regions.

The foregoing has shown that scheduling regions are not necessarily good for the purpose of register allocation, even by compile-time considerations only. Methods disclosed herein for region formation and allocation collectively improve both compile-time and run-time over a global allocator. In addition to the inclusion of the register pressure estimate to the single-versus-multiple regions decision and to priority order allocations of regions, one may use it directly in the region formation process. The current region structures for Fpr and Gpr—if both classes use multiple regions—are almost identical, close to the nodeRegion algorithm disclosed herein.

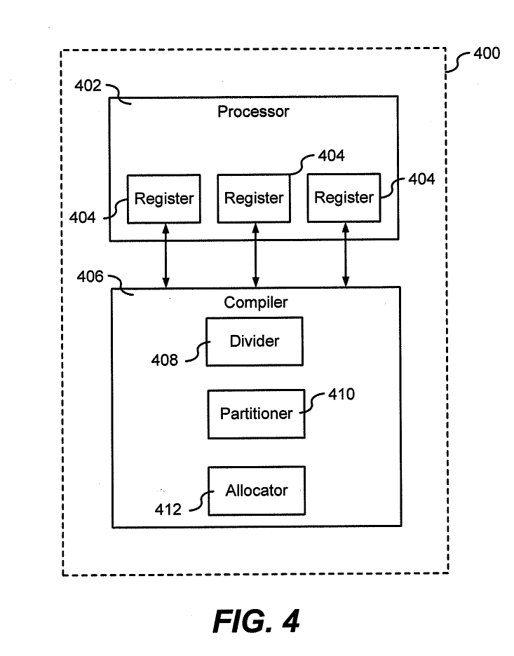

FIG. 4 depicts a block diagram of a computing system 400 according to embodiments of the present invention, comprising a processor 402 including a plurality of registers 404, and a compiler 406 including a divider 408, a partitioner 410, and an allocator 412.

Data and instructions (of the various code sequences, software or firmware modules) are stored in one or more machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs).

While various exemplary embodiments have been described above, it should be understood that they have been presented by way of example only, and not limitation. Thus, the breadth and scope of the present invention should not be limited by any of the above-described exemplary embodiments, but should instead be defined only in accordance with the following claims and their equivalents.

What is claimed is:

1. A computing system, comprising:
a processor including a plurality of registers; and
a compiler arranged to allocate register space among the plurality of registers in the processor, wherein said compiler includes:
a divider for dividing the plurality of registers into a plurality of register classes, and for each such register class from said plurality of register classes,
a partitioner for partitioning instructions of a procedure into a plurality of regions, and
an allocator for allocating each of said plurality of regions to the plurality of registers in said register class based on a characteristic of said procedure.

2. The computing system according to claim 1, further comprising:
code sequences for calculating a register pressure in a control-flow graph of said procedure;
code sequences for determining if said register pressure exceeds a threshold value; and
code sequences for allocating said procedure as a single region in the event that said register pressure does not exceed said threshold value.

3. The computing system according to claim 2, wherein said threshold value comprises a number of physical registers.

4. The computing system according to claim 1, wherein said partitioner comprises:
code sequences for partitioning a control flow graph of the procedure into a hierarchical interval graph; and
code sequences for scheduling regions based on the hierarchical interval graph.

5. A method for allocating register space among a plurality of registers in a processor, comprising:
dividing the plurality of registers into a plurality of register classes; and
for a register class from the plurality of register classes,
partitioning instructions of a procedure into a plurality of regions; and
allocating each of said plurality of regions to the plurality of registers in the register class based on a characteristic of said procedure.

6. The method according to claim 5, wherein the partitioning step comprises:
forming said plurality of regions along a syntactic construct of instructions of said procedure.

7. The method according to claim 5, wherein the partitioning step comprises:
forming a region using a frequently used basic block of instructions of said procedure; and
expanding said region along the frequently executed predecessors and successors of said basic block.

8. The method according to claim 5, wherein the partitioning step comprises:
partitioning a control flow graph of the procedure into a hierarchical interval graph; and
scheduling regions based on the hierarchical interval graph.

9. The method according to claim 5, further comprising, before the partitioning step:
calculating a register pressure in a control-flow graph of the procedure;
determining if the register pressure exceeds a threshold value; and
if not, allocating the procedure as a single region.

10. The method according to claim 9, wherein the calculating step comprises:
traversing basic blocks of the procedure to determine the number of live variables at each instruction in the procedure; and
assigning the largest number of live variables corresponding to an instruction among all instructions in the procedure as the register pressure.

11. The method according to claim 10, wherein the threshold value is the number of physical registers.

12. A computer-readable storage medium containing instructions that, when executed on a computer, cause the computer to perform a method comprising:
dividing the plurality of registers into a plurality of register classes; and
for a register class from the plurality of register classes,
partitioning instructions of a procedure into a plurality of regions; and
allocating each of said plurality of regions to the plurality of registers in the register class based on a characteristic of said procedure.

13. The computer-readable storage medium according to claim 12, wherein the partitioning step comprises:
forming said plurality of regions along a syntactic construct of instructions of said procedure.

14. The computer-readable storage medium according to claim 12, wherein the partitioning step comprises:
forming a region using a frequently used basic block of instructions of said procedure; and
expanding said region along the frequently executed predecessors and successors of said basic block.

15. The computer-readable storage medium according to claim 12, wherein the partitioning step comprises:
partitioning a control flow graph of the procedure into a hierarchical interval graph; and
scheduling regions based on the hierarchical interval graph.
